(19) United States
(12) Patent Application Publication
(10) Pub. No.: US 2008/0079751 A1
(43) Pub. Date: Apr. 3, 2008

(54) Virtual graffiti

(75) Inventor: Juha Arrasvuori, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/541,799

(22) Filed: Oct. 3, 2006

(51) Int. Cl. G09G 5/00

(52) U.S. Cl. 345/629

(57) ABSTRACT

An application is disclosed, the application comprising an image content receiving module for receiving image content from a remote image providing apparatus, wherein said image content receiving module further comprises an image viewer arranged to invoke received image content into a view of a graphical user interface of a communication apparatus holding the application and/or the application comprising an image content providing module for providing image content to a remote image content receiving apparatus, wherein said image content providing module further comprises an image editor arranged to prepare image content invokable into a view of a graphical user interface of said remote image content receiving apparatus, and to send said image content to said remote image content receiving apparatus. A communication apparatus holding such an application, corresponding methods and computer programs, and a system for implementing the invention is also disclosed.

### TECHNICAL FIELD

The present invention relates to applications, communication apparatuses, methods, computer programs and a system for providing and/or invoking image content to a graphical user interface view.

### BACKGROUND OF THE INVENTION

Many communication apparatuses comprises a graphical user interface (GUI) enabling a user to interact with the apparatus. Many ways for personalizing the GUI have been presented, such as personalized background images or themes. However, there is still a need for improving the GUI by personalizing.

### SUMMARY OF THE INVENTION

In view of the above, an objective of the invention is to solve or at least reduce the problems discussed above. In particular, an objective is to enhance a social aspect of personalizing the GUI.

According to a first aspect of the present invention, there is provided an application comprising an image content receiving module for receiving image content from a remote image providing apparatus, wherein said image content receiving module further comprises an image viewer arranged to invoke received image content into a view of a graphical user interface of a communication apparatus holding the application.

The application may further comprise an image content providing module for providing image content to a remote image content receiving apparatus, wherein said image content providing module further comprises an image editor arranged to prepare image content invokable into a view of a graphical user interface of said remote image content receiving apparatus, and to send said image content to said remote image content receiving apparatus.

The image content may comprise a personal tag. The received image content may be invoked into an existing background image of said view.

According to a second aspect of the present invention, there is provided an application comprising an image providing module for providing image content to a remote image content receiving apparatus, wherein said image content providing module further comprises an image editor arranged to prepare image content invokable into a view of a graphical user interface of said remote image content receiving apparatus, and to send said image content to said remote image content receiving apparatus.

The application may further comprise an image content receiving module for receiving image content from a remote image providing apparatus, wherein said image content receiving module further comprises an image viewer arranged to invoke said received image content into a graphical user interface view.

The image providing module may have access to an image content library.

The image editor may be user interactable for enabling a user to create said image content.

According to a third aspect of the present invention, there is provided a communication apparatus comprising a receiver arranged to receive a signal, wherein said signal comprises a representation of image content; a graphical user interface; and an image content receiving module for processing said received image content from a remote image providing apparatus, wherein said image content receiving module further comprises an image viewer arranged to invoke received image content into a view of said graphical user interface.

The communication apparatus may further comprise a transmitter; and an image providing module for providing image content to a remote image content receiving apparatus, wherein said image content providing module further comprises an image editor arranged to prepare image content invokable into a view of a graphical user interface of said remote image content receiving apparatus, wherein said transmitter is arranged to send said image content to said remote image content receiving apparatus.

The image content may comprise a personal tag.

The received image content may be invoked into an existing background image of said view.

According to a fourth aspect of the present invention, there is provided a communication apparatus comprising a transmitter; and an image providing module for providing image content to a remote image content receiving apparatus, wherein said image content providing module further comprises an image editor arranged to prepare image content invokable into a view of a graphical user interface of said remote image content receiving apparatus, wherein said transmitter is arranged to send said image content to said remote image content receiving apparatus.

The communication apparatus may further comprise a receiver arranged to receive a representation of image content; a graphical user interface; and an image content receiving module for processing said received image content from a remote image providing apparatus, wherein said image content receiving module further comprises an image viewer arranged to invoke received image content into a view of said graphical user interface.

The invokable image content may comprise a personal tag. The image providing module may have access to an image content library. The image editor may be user interactable for enabling a user to create said image content.

According to a fifth aspect of the present invention, there is provided a method for invoking image content into a graphical user interface view of a communication apparatus, the method comprising receiving image content from a remote communication apparatus; invoking said image content into said graphical user interface view; and viewing said graphical interface view.

The invoking of image content may comprise invoking said image content into an existing background image of said graphical user interface view.

According to a sixth aspect of the present invention, there is provided a method for providing image content to a graphical user interface view of a remote communication apparatus, the method comprising preparing image content to be invokable into said graphical user interface view; and sending said image content to said remote communication apparatus.

The preparing may further comprise accessing image content from an image content library; and editing said accessed image content, or comprise enabling a user to interactively create said image content.

According to a seventh aspect of the present invention, there is provided a computer-readable medium having computer-executable components comprising instructions for invoking image content into a graphical user interface view of a communication apparatus by receiving image content from a remote communication apparatus; invoking said image content into said graphical user interface view; and viewing said graphical interface view.

The instructions for invoking of image content may comprise instructions for invoking said image content into an existing background image of said graphical user interface view.

According to an eighth aspect of the present invention, there is provided a computer-readable medium having computer-executable components comprising instructions for providing image content to a graphical user interface view of a remote communication apparatus by preparing image content to be invokable into said graphical user interface view; and sending said image content to said remote communication apparatus.

The instructions for preparing may further comprise instructions for accessing image content from an image content library; and editing said accessed image content.

The instructions for preparing may further comprise instructions for enabling a user to interactively create said image content.

According to a ninth aspect of the present invention, there is provided a system comprising a telecommunication network and a first and a second communication apparatus arranged to communicate with said telecommunication network, wherein said telecommunication network comprises an image content invokation service for invoking image content into a graphical user interface view of said first communication apparatus by said second communication apparatus.

The system may further comprise an image content invokation service center for handling said image content invokation service. The system according may further comprise an image content server associated to said image content invokation service center. The system may further comprise an image content invokation gateway interconnecting said image content invokation service center and said telecommunication network.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 schematically illustrates an application according to an embodiment of the present invention;

FIG. 2 schematically illustrates a communication apparatus according to an embodiment of the present invention;

FIG. 3 is a flow chart illustrating a method for invoking image content into a GUI view of a receiving communication apparatus;

FIG. 4 is a flow chart illustrating basic operations of a method for providing image content to a GUI view of a remote communication apparatus;

FIG. 5 is a flow chart illustrating a method according to an embodiment of the present invention for providing image content to a GUI view of a remote communication apparatus;

FIG. 6 is a flow chart illustrating a method according to an embodiment of the present invention for providing image content to a GUI view of a remote communication apparatus;

FIG. 7 schematically illustrates a computer-readable medium comprising computer-executable components with instructions to be executed in a device comprising a processor;

FIG. 8 schematically illustrates a system architecture for managing a system according to an embodiment of the present invention; and

FIG. 9 illustrates a use case according to an embodiment of the present invention.

### DETAILED DESCRIPTION OF PREFERRED EMBODIMENTS

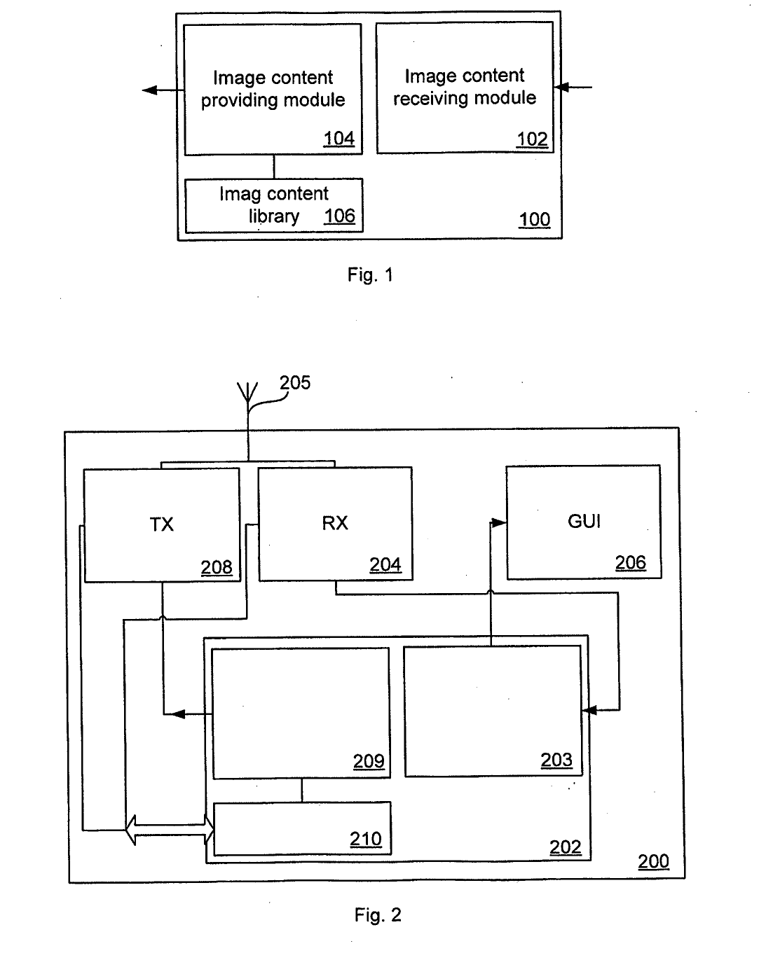

FIG. 1 schematically illustrates an application 100 according to an embodiment of the present invention. The application 100 can comprise an image content receiving module 102. The image content receiving module 102 is arranged to receive image content, such as e.g. a tag that may look like it is hand drawn, from a remote apparatus, e.g. from a friend's mobile phone. The image content receiving module 102 is further arranged to invoke the received image content into a view of a graphical user interface of a communication apparatus on which the application is implemented. This invokation can for example be a tag drawn on a background image, also called “wallpaper”, of the graphical user interface (GUI). This provides for a way of paying attention to someone by leaving a sign on the GUI of the persons communication apparatus in an electronic manner. To make this neat an feasible, the receiver of the image content preferably has allowed this type of image content on the communication apparatus, either for anyone, or for a selected group of senders of image content.

The application 100 can also comprise an image content providing module 104. The application can comprise both the image content receiving module 102 and the image content providing module 104, but can also comprise any of these 102, 104 separately. The image content providing module 104 can comprise an image editor for preparing an image to be invokable by a similar application as 102, but on another remote apparatus. Thus, the image content providing module 104 is also arranged to send the prepared image content, e.g. via any available communication interface of the apparatus on which the application 100 is implemented. The preparation of an image can either be created by a user from scratch by a creation function of the image content providing module 104, or by accessing an image content library 106 holding one or more images, and eventually being edited by a user, and/or being prepared for sending by the image content providing module.

FIG. 2 schematically illustrates a communication apparatus 200 according to an embodiment of the present invention. The communication apparatus 200 comprises an application 202, which can be any of the types described with reference to FIG. 1. The communication apparatus 200 can further comprise a receiver 202 which is capable of receiving a signal comprising a representation of image content. The signal can be communicated to the communication apparatus wirelessly, e.g. to an antenna 205, which is connected to the receiver 204. The image content is thus extracted and provided to the application 202 where it is handled by an image content receiving module 203, which in turn, as described with reference to FIG. 1, provides the image content in a view of a graphical user interface (GUI) 206 of the communication apparatus 200, e.g. by invoking the image content into an existing background image of the GUI 206.

The communication apparatus 200 can also comprise a transmitter 208, which in the wireless example above is connected to the antenna 205, and capable of sending image content to a remote communication apparatus (not shown). The communication apparatus 200 can either be capable to receive and invoke image content as described above, or be capable to provide and transmit image content as described above. Preferably, the communication apparatus 200 has both these capabilities, and that enablement of these capabilities is user controlled. The transmitter 208 is provided image content from an image content providing module 209 of the application 202. The features of the image content providing module 209 are similar to those demonstrated for the image content providing module 104 in FIG. 1, and can be capable of accessing an image content library 210 similar to the image content library 116 of FIG. 1. The image content that is sent by the transmitter 208 is preferably in a predetermined format to be able to be received and invoked into a GUI view of the remote communication apparatus. The communication apparatus 200 can for example be a mobile phone, a personal digital assistant, or any communication apparatus utilizing a GUI.

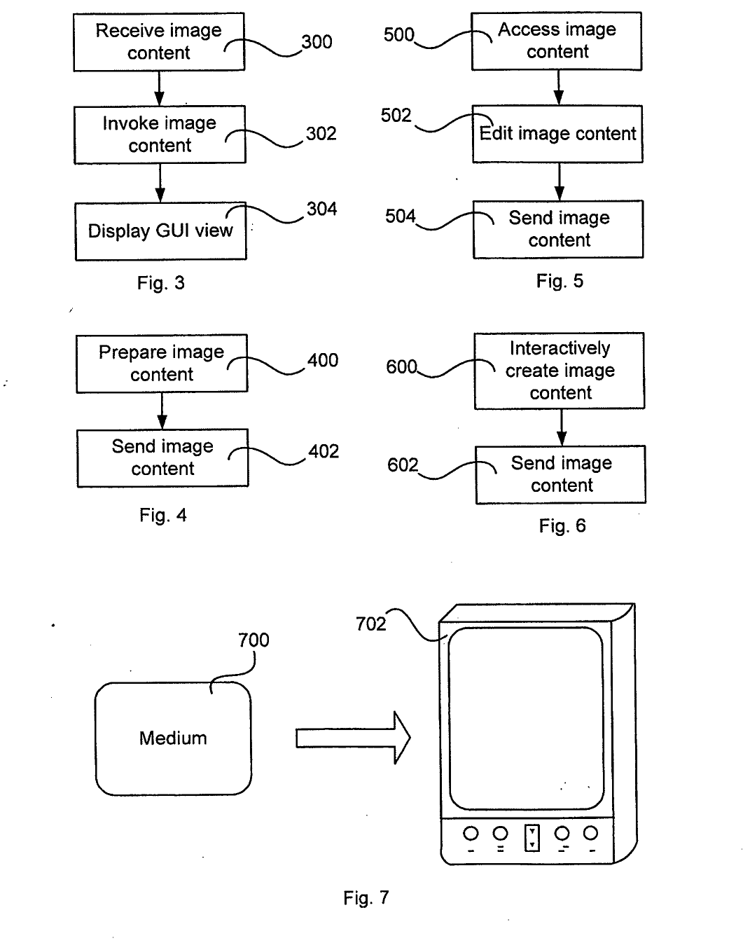

FIG. 3 is a flow chart illustrating a method for invoking image content into a GUI view of a receiving communication apparatus. The image content is received 300 from a remote communication apparatus. Then, the image content is invoked 302 into the GUI view. This is preferably performed by a graphics mechanism of the receiving communication apparatus by merging the received image content and an existing GUI view, e.g. a background image of the GUI. The purpose of the merging operation is to make the image content look like it is painted or sticked to the existing GUI view. The merged GUI view is then displayed 304 in a similar way as the existing GUI view was displayed.

FIG. 4 is a flow chart illustrating basic operations of a method for providing image content to a GUI view of a remote communication apparatus. Image content is prepared 400 to be invokable into the GUI view of the remote communication apparatus. This is preferably performed such that a graphics mechanism of the remote communication apparatus is able to merge the received image content and an existing GUI view, e.g. a background image of the GUI. The purpose of the merging operation is to make the image content look like it is painted or sticked to the existing GUI view of the remote communication apparatus. When the image content is prepared, it is sent 402 to the remote communication apparatus. This can for example be performed over a short range communication link, such as Bluetooth, IrDA, etc., or over a communication network, such as a cellular communication system.

FIG. 5 is a flow chart illustrating a method according to an embodiment of the present invention for providing image content to a GUI view of a remote communication apparatus. Image content is accessed 500 from an image content library. The image content is then edited 502 e.g. to create a personal touch to the image content. Image content is also prepared to be invokable into the GUI view of the remote communication apparatus. This is preferably performed such that a graphics mechanism of the remote communication apparatus is able to merge the received image content and an existing GUI view, e.g. a background image of the GUI. The purpose of the merging operation is to make the image content look like it is painted or sticked to the existing GUI view of the remote communication apparatus. When the image content is prepared, it is sent 504 to the remote communication apparatus in a similar way as described for the general image providing method described with reference to FIG. 4.

FIG. 6 is a flow chart illustrating a method according to an embodiment of the present invention for providing image content to a GUI view of a remote communication apparatus. Image content is interactively with a user created 600. Image content is also prepared to be invokable into the GUI view of the remote communication apparatus. This is preferably performed such that a graphics mechanism of the remote communication apparatus is able to merge the received image content and an existing GUI view, e.g. a background image of the GUI. The purpose of the merging operation is to make the image content look like it is painted or sticked to the existing GUI view of the remote communication apparatus. When the image content is prepared, it is sent 602 to the remote communication apparatus in a similar way as described for the general image providing method described with reference to FIG. 4.

FIG. 7 schematically illustrates a computer-readable medium 700 comprising computer-executable components with instructions to be executed in a device 702 comprising a processor. The device 702 can for example be a cell phone, a personal digital assistant, a personal computer, or a contact information server. The instructions enable the device to perform the actions discussed with reference to FIGS. 3 to 6.

The present invention can be used on a peer-to-peer level, i.e. one user put a tag or other image content into the display view of another user, e.g. via a short range technique, such as Bluetooth technology, or over a cellular communication network.

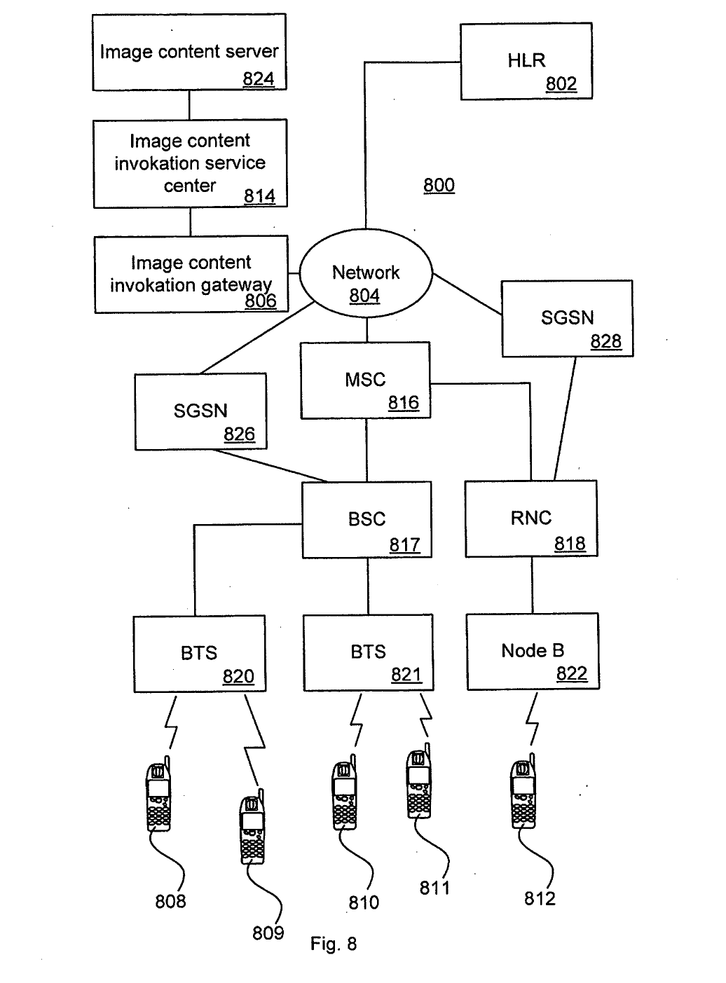

A system architecture for managing a system 800 according to an embodiment of the present invention is shown in FIG. 8. A Home Location Register (HLR) 802 contains a database (not shown) including relevant subscriber information for provision of telecommunication service. A CCITT specified network 804 interconnects the individual parts of the system 800. An advertising gateway 806 is a switching unit routing an advertising message to a mobile communication apparatus 808-812. An Advertising Service Center 814 (ASC) and the advertising gateway 806 handles and routes the advertising messages between the ASC 814 and the network 804. From the network 804, the image content messages are routed to the mobile communication apparatuses 808-812 via a Mobile Switching Center (MSC) 816 to a Base Station Controller (BSC) 817 and a Base Transceiver Station (BTS) 820, 821, or a Radio Network Controller (RNC) 818 and a Node B 822. Alternatively, the image content messages are routed to the mobile communication apparatuses 808-812 via a Serving GPRS Support Node (SGSN) 826, 828 to the BSC 817 and the BTS 820, 821, or the RNC 818 and the Node B 822, respectively. The BTS 820, 821 or the Node B 822 establish the air connection to the mobile communication apparatuses 808-812.

According to an embodiment of the present invention, a network operator or other third party company handling an image content server 824 could offer an image content function for image content invokation. For example a network operator may have an image content server 824 supporting a feature where the “sender” may provide for example a tag and the “receiver” may send an invokation admission from their mobile communication apparatuses 808-812 to the image content server 824, and in exchange for the admission be provided the ability to be a sender themselves, and tag other receivers. This image content server 824 automatically may place people sending a similar admission to the image content server 824 into “tagging groups” or “graffiti walls”.

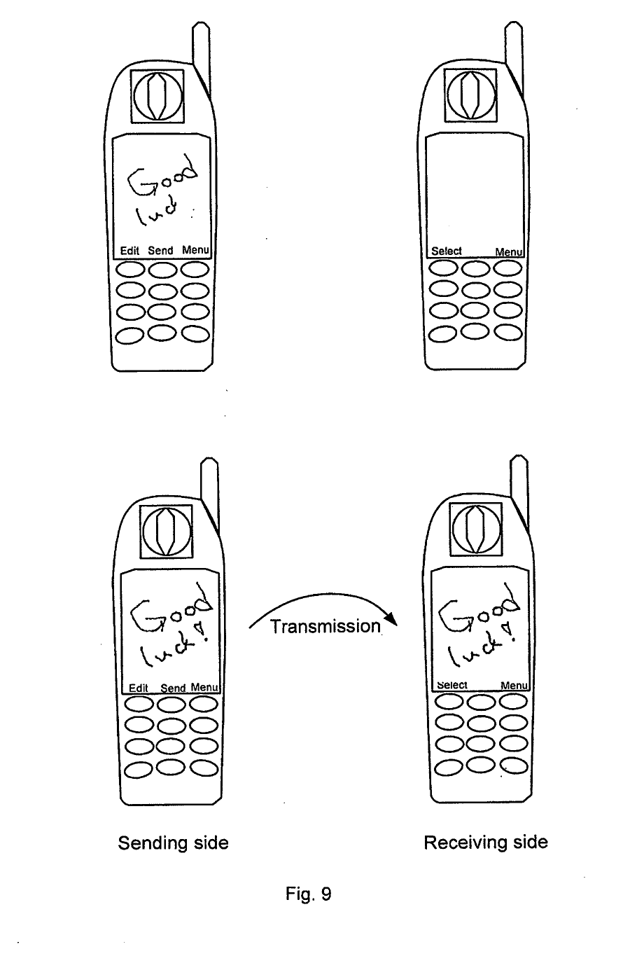

FIG. 9 illustrates a use case where a first user (left side) provides image content to a second user (right side) having a communication apparatus with an existing GUI view (upper right). The first user creates image content (upper left) and, when the first user is satisfied with the image content, sends (lower left) the image content to the second user. The GUI view of the second user's communication apparatus then invokes the image content into the existing GUI view and displays a merged GUI view (lower right).

The invention has mainly been described above with reference to a few embodiments. However, as is readily appreciated by a person skilled in the art, other embodiments than the ones disclosed above are equally possible within the scope of the invention, as defined by the appended patent claims.

1. An application comprising an image content receiving module for receiving image content from a remote image providing apparatus, wherein said image content receiving module further comprises an image viewer arranged to invoke received image content into a view of a graphical user interface of a communication apparatus holding the application.

2. The application according to claim 1, further comprising an image content providing module for providing image content to a remote image content receiving apparatus, wherein said image content providing module further comprises an image editor arranged to prepare image content invokable into a view of a graphical user interface of said remote image content receiving apparatus, and to send said image content to said remote image content receiving apparatus.

3. The application according to claim 1, wherein said image content comprises a personal tag.

4. The application according to claim 1, wherein said received image content is invoked into an existing background image of said view.

5. An application comprising an image providing module for providing image content to a remote image content receiving apparatus, wherein said image content providing module further comprises an image editor arranged to prepare image content invokable into a view of a graphical user interface of said remote image content receiving apparatus, and to send said image content to said remote image content receiving apparatus.

6. The application according to claim 5, further comprising an image content receiving module for receiving image content from a remote image providing apparatus, wherein said image content receiving module further comprises an image viewer arranged to invoke said received image content into a graphical user interface view.

7. The application according to claim 5, wherein said invokable image content comprises a personal tag.

8. The application according to claim 5, wherein said image providing module has access to a image content library.

9. The application according to claim 5, wherein said image editor is user interactable for enabling a user to create said image content.

10. A communication apparatus comprising a receiver arranged to receive a signal, wherein said signal comprises a representation of image content;
a graphical user interface; and
an image content receiving module for processing said received image content from a remote image providing apparatus, wherein said image content receiving module further comprises an image viewer arranged to invoke received image content into a view of said graphical user interface.

11. The communication apparatus according to claim 10, further comprising
a transmitter; and
an image providing module for providing image content to a remote image content receiving apparatus, wherein said image content providing module further comprises an image editor arranged to prepare image content invokable into a view of a graphical user interface of said remote image content receiving apparatus, wherein
said transmitter is arranged to send said image content to said remote image content receiving apparatus.

12. The communication apparatus according to claim 10, wherein said image content comprises a personal tag.

13. The communication apparatus according to claim 10, wherein said received image content is invoked into an existing background image of said view.

14. A communication apparatus comprising
a transmitter; and
an image providing module for providing image content to a remote image content receiving apparatus, wherein said image content providing module further comprises an image editor arranged to prepare image content invokable into a view of a graphical user interface of said remote image content receiving apparatus, wherein
said transmitter is arranged to send said image content to said remote image content receiving apparatus.

15. The communication apparatus according to claim 14, further comprising
a receiver arranged to receive a representation of image content;
a graphical user interface; and
an image content receiving module for processing said received image content from a remote image providing apparatus, wherein said image content receiving module further comprises an image viewer arranged to invoke received image content into a view of said graphical user interface.

16. The communication apparatus according to claim 14, wherein said invokable image content comprises a personal tag.

17. The communication apparatus according to claim 14, wherein said image providing module has access to a image content library.

18. The communication apparatus according to claim 14, wherein said image editor is user interactable for enabling a user to create said image content.

19. A method for invoking image content into a graphical user interface view of a communication apparatus, the method comprising
receiving image content from a remote communication apparatus;
invoking said image content into said graphical user interface view; and
viewing said graphical interface view.

20. The method according to claim 19, wherein said invoking of image content comprises invoking said image content into an existing background image of said graphical user interface view.

21. A method for providing image content to a graphical user interface view of a remote communication apparatus, the method comprising
preparing image content to be invokable into said graphical user interface view; and
sending said image content to said remote communication apparatus.

22. The method according to claim 21, wherein said preparing further comprises
accessing image content from a image content library; and
editing said accessed image content.

23. The method according to claim 21, wherein said preparing further comprises
enabling a user to interactively create said image content.

24. A computer-readable medium having computer-executable components comprising instructions for invoking image content into a graphical user interface view of a communication apparatus by
receiving image content from a remote communication apparatus;
invoking said image content into said graphical user interface view; and
viewing said graphical interface view.

25. The medium according to claim 24, wherein said instructions for invoking of image content comprises instructions for invoking said image content into an existing background image of said graphical user interface view.

26. A computer-readable medium having computer-executable components comprising instructions for providing image content to a graphical user interface view of a remote communication apparatus by
preparing image content to be invokable into said graphical user interface view; and
sending said image content to said remote communication apparatus.

27. The medium according to claim 26, wherein said instructions for preparing further comprises instructions for
accessing image content from a image content library; and
editing said accessed image content.

28. The medium according to claim 26, wherein said instructions for preparing further comprises instructions for enabling a user to interactively create said image content.

29. A system comprising a telecommunication network and a first and a second communication apparatus arranged to communicate with said telecommunication network, wherein said telecommunication network comprises an image content invokation service for invoking image content into a graphical user interface view of said first communication apparatus by said second communication apparatus.

30. The system according to claim 29, further comprising an image content invokation service center for handling said image content invokation service.

31. The system according to claim 30, further comprising an image content server associated to said image content invokation service center.

32. The system according to claim 30, further comprising an image content invokation gateway interconnecting said image content invokation service center and said telecommunication network.
